(19) United States
(12) Patent Application Publication
(10) Pub. No.: US 2026/0220527 A1
(43) Pub. Date: Jul. 30, 2026

(54) EFFICIENT AUTOML DURING DATA DRIFTS VIA CONFIGURATION ESTIMATION

(71) Applicant: Oracle International Corporation, Redwood Shores, CA (US)

(72) Inventors: Ali Seyfi, Vancouver (CA); Moein Owhadi Kareshk, Burnaby (CA); Hesam Fathi Moghadam, Sunyvale, CA (US); Rhicheek Patra, Zurich (CH); Hassan Chafi, Zurich (CH)

(21) Appl. No.: 19/039,637

(22) Filed: Jan. 28, 2025

(51) Int. Cl. G06N 20/00

(52) U.S. Cl. CPC G06N 20/00

(57) ABSTRACT

For a new batch of datapoints during a detected data drift, without decreasing accuracy nor increasing volatility of accuracy, noniterative selection of a new hyperparameters configuration accelerates generating a retrained machine learning model. For each batch in a sequence of recent batches of datapoints that includes a last batch of datapoints, a computer stores: the batch, a hyperparameter value for an unsupervised model, and an accuracy measurement, for the unsupervised model, that is based on both of the hyperparameter value and the batch. With a retraining corpus that contains the new batch and the batches in the sequence of recent batches, a new hyperparameter value is predicted. Based on the retraining corpus and the new hyperparameter value, a new accuracy measurement is estimated. In response to detecting that the new accuracy measurement exceeds an accuracy threshold, retraining the unsupervised model with the retraining corpus is unconventionally accelerated.

### FIELD OF THE INVENTION

For a new batch of datapoints during a detected data drift, without decreasing accuracy nor increasing volatility of accuracy, noniterative selection of a new hyperparameters configuration accelerates generating a retrained machine learning model.

### BACKGROUND

The machine learning (ML) model is trained on a training dataset, validated, and then deployed into a production environment. Learning does not occur in the production environment. A dataset in the production environment can be a nearly infinite stream of incoming data. Although machine learning models can be made somewhat robust to input noise, they cannot handle input data distribution changes, which is a phenomenon called concept drift or data drift.

In one example, concept drift occurs when a series of inputs evolves over time such that later normal inputs have feature values that are no longer within the value range of earlier normal inputs such as training inputs. For example, a reconstructive model may be a classifier that learned to distinguish normal tree seedlings from normal weeds because seedlings are smaller than weeds. However over time, seedlings may grow to be a same size as weeds or grow into trees that are bigger than weeds, which may confuse the classifier. For example, the classifier may mistakenly classify an older seedling as a weed.

Concept drift may have various causes. For example, seasonality may cause a normal temperature range to shift such that a normal temperature may be mistakenly detected as anomalous or an abnormal temperature may be mistakenly detected as non-anomalous. Seasonality may influence consumer preferences which may interfere with a predictive machine learning model for a supply chain or for behavioral advertisement targeting.

Concept drift naturally happens in many or most real-world systems, where the system is inherently dynamic or dependent on dynamic parameters such as the evolving state of a server machine in time. Such shifts in data are usually inevitable because the system is dynamic and cannot be controlled or predicted in every aspect. Moreover, machine learning model performance is highly dependent on the distribution of previous data involved during a training phase. After fitting to training data, a machine learning model may be unable to handle concept drift.

In industry, an existing solution for concept drift is usually to retrain the machine learning model with new data, in which case, the retrained model learns the new distribution of the data and can accurately perform after the concept drift that necessitated retraining. However, retraining a machine learning model and redeploying it after a concept drift usually takes much time. Thus, retraining may impose a somewhat prolonged service outage of a machine learning model.

### BRIEF DESCRIPTION OF THE DRAWINGS

In the drawings:

FIG. 1 is a block diagram that depicts an example computer that, for a new batch of new datapoints during a detected data drift in a continuous feed, noniteratively selects a new hyperparameters configuration that includes a new hyperparameter value to accelerate generating a retrained unsupervised model without decreasing accuracy nor increasing volatility of accuracy;

FIG. 2 is a flow diagram that depicts a computer process that, for a new batch of new datapoints during a detected data drift in a continuous feed, noniteratively selects a new hyperparameters configuration that includes a new hyperparameter value to accelerate generating a retrained unsupervised model without decreasing accuracy nor increasing volatility of accuracy;

FIG. 3 is a flow diagram that depicts a computer process that handles recurring data drift;

FIG. 4 is a block diagram that illustrates a computer system upon which an embodiment of the invention may be implemented;

FIG. 5 is a block diagram that illustrates a basic software system that may be employed for controlling the operation of a computing system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### GENERAL OVERVIEW

For a new batch of datapoints during a detected data drift, without decreasing accuracy nor increasing volatility of accuracy, noniterative selection of a new hyperparameters configuration accelerates generating a retrained machine learning (ML) model. This approach estimates configurations of an automatic ML (AutoML) pipeline instead of actually executing the whole pipeline to find new configurations based on new data. The AutoML pipeline herein can be executed slowly from scratch on the first batch of data. Then, when each subsequent batch of data arrives, this approach estimates a reconfiguration of the AutoML pipeline using historical configurations. For accelerated exploration, the accuracy of the pipeline with an estimated configuration is evaluated on a subset of the new batch.

The purpose of the ML pipeline is to develop an accurate ML model. The ML pipeline consists of a sequence of distinct ML stages such as model selection, feature selection, iterative hyperparameter tuning, and training with validation. Hyperparameter tuning is by far the slowest stage, and skipping hyperparameter tuning provides an order of magnitude of unconventional acceleration of generation of a retrained ML model.

In a production environment after deployment, data drift (a.k.a. concept drift) renders the ML model more or less inaccurate or, in severe cases, effectively useless. Data drift is a long-term shift in data distribution that is substantial enough to decrease accuracy of an ML model. Although there may be other reason(s) to retrain the ML model, in some environments, data drift is the most frequent reason to retrain the ML model. For example, an anomaly detector ML model that generates too many false alarms (i.e. false positives) may be effectively useless and should be ignored until retrained with more recent data (i.e. post-drift data).

Herein, a pipeline configuration is initially empty metadata that accumulates additional information at each pipeline stage. In other words, a pipeline configuration monotonically gains specificity as it progresses through the stages of the ML pipeline, and this growing specificity is based on a corpus of recent production data. Herein, this monotony of specificity based on recent data facilitates a new, hybrid way to accelerate the ML pipeline for most retrainings. Herein, a current retraining is a hybrid of: a) recent pipeline configuration(s) from recent (but not new) data and b) new production data. This novel hybrid way is referred to herein as pipeline configuration extrapolation that, due to leveraging recent pipeline configuration(s), provides acceleration by conditionally avoiding some pipeline stages. Herein, all pipeline stages are conditionally avoidable except for the last stage, which is retraining with recent data. Herein, most data drifts are small enough to compensate for by extrapolating a new configuration from recent configuration(s) of the ML pipeline and then retraining with the new configuration. Unlike the state of the art, most data drifts can be mitigated without executing the whole ML pipeline.

A few data drifts are so extreme that pipeline configuration extrapolation does not work, which is referred to herein as hyperparameter validation failure because the extrapolated hyperparameter(s) value(s) of the ML model cannot handle the post-drift data even with retraining. Hyperparameter validation failure is quickly and automatically detected, in which case fallback occurs that entails executing the whole ML pipeline to maximize accuracy of the ML model and might, for example, entail selecting a different model type. In one example, executing the whole ML pipeline might cause switching the ML model from a random forest to an artificial neural network or vice versa. In another example of executing the whole ML pipeline, the model selection stage reselects the same model type as before, but the iterative hyperparameter tuning stage selects better hyperparameter(s) value(s) that maximize the accuracy of the ML model when retrained with drifted data.

This approach includes the following innovations. This approach has cost-effective (i.e. fast and accurate) dynamic configuration estimation. Unlike traditional methods that retrain the entire AutoML pipeline from scratch, this approach estimates (i.e. extrapolates) configurations of the pipeline based on historically optimized configurations for recent data, and this inherently compensates for deviations due to data drift. This significantly decreases a computer’s time and space required to adapt to concept drift. By using a subset of new data to validate and adjust pipeline configurations, our solution also minimizes the costs associated with retraining models, leading to faster and more cost-effective adaptation to changing data patterns.

This approach has smooth adaptation and enhanced stability. By leveraging the configurations from the initial batch and applying them to subsequent data batches, this approach provides continuous and seamless updates to the AutoML pipeline, ensuring the ML model remains accurate and up-to-date without extensive experimentation on the ML model. Focusing on configuration estimation, this approach maintains the stability of the AutoML pipeline across multiple stages (model selection, feature selection, model tuning), ensuring consistent (i.e. low volatility) performance even in the presence of most data drifts. This approach smooths out sudden changes in pipeline configurations across adjacent batches, providing a more robust solution by avoiding unsmooth configuration changes and ensuring more stable and reliable ML model accuracy.

This approach provides the following technologic and technical advantages. This approach is agnostic to the method of concept drift detection. It does not matter if drift is detected by monitoring accuracy of the ML model or by statistically analyzing the input data feed itself. It does not matter whether or not drift detection is based on domain-specific details such as semantics, heuristics, techniques, and human expertise. In an embodiment, drift detection is automatic. When the ML model is unsupervised, a reaction to detected drift such as retraining or redeveloping the unsupervised model may be entirely automatic. Herein, executing the whole ML pipeline may be referred to as developing the ML model, and retraining the ML model by executing the whole ML pipeline may be referred to as redeveloping.

This approach is agnostic to the architecture of the AutoML pipeline, its stages, and the possible pipeline configurations. For example, this approach supports M L pipelines having different counts of stages.

This approach is agnostic to how changes in AutoML configurations are predicted (i.e. extrapolated). When there is no concept drift, this approach only does configuration estimation, evaluation on a small subset of the data, and refitting the final model which is still more efficient than redeveloping an ML model by executing a whole AutoML pipeline from scratch.

### EXAMPLE COMPUTER

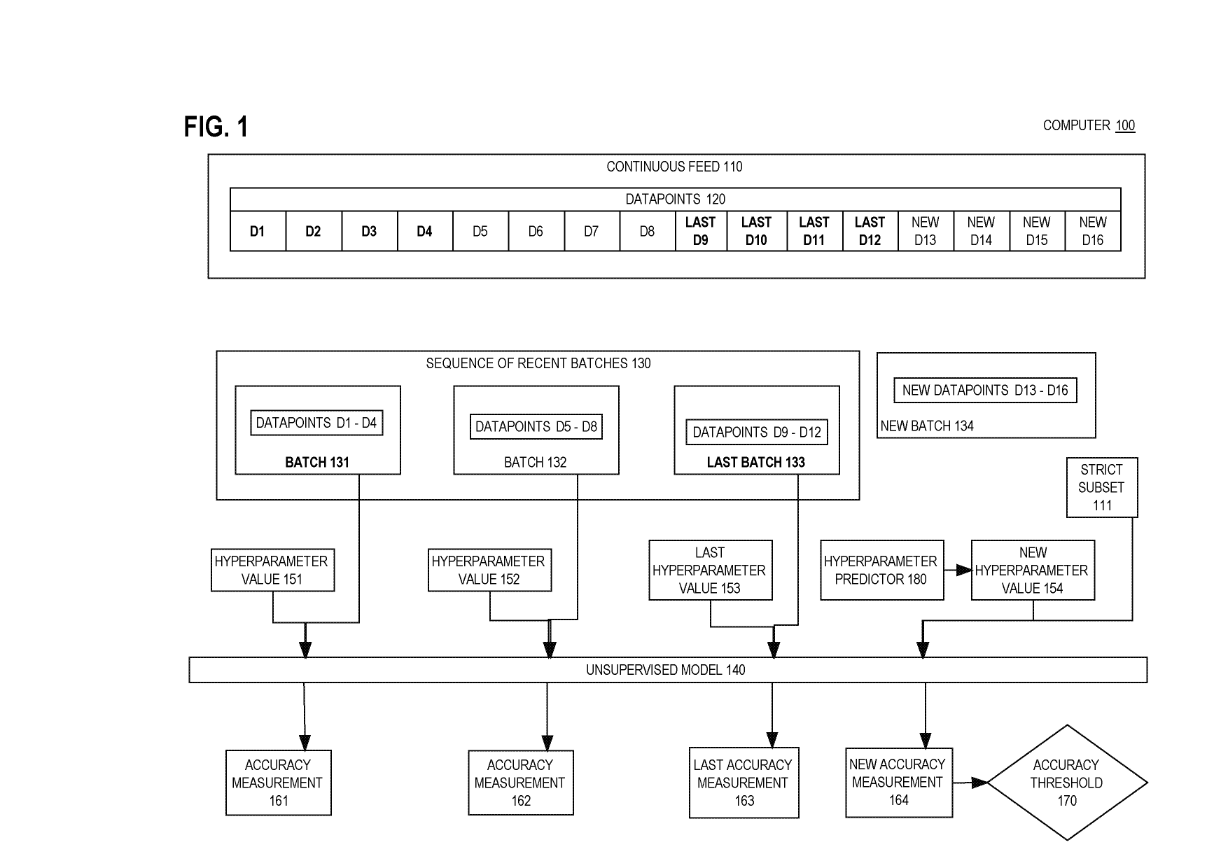

FIG. 1 is a block diagram that depicts an example computer 100 that, for new batch 134 of new datapoints D13-D16 during a detected data drift in continuous feed 110, noniteratively selects a new hyperparameters configuration that includes new hyperparameter value 154 to accelerate generating a retrained unsupervised model 140 without decreasing new accuracy measurement 164 nor increasing volatility of accuracy measurement 164. Computer 100 may be one or more computers such as a rack server such as a blade, a personal computer, a mainframe, or a virtual computer. Except for an entire extent (not shown) of continuous feed 110, all of the remaining shown components, including datapoints 120, may be respectively stored and operated in volatile or nonvolatile storage of computer 100.

Model 140 is a machine learning (ML) model that is unsupervised as discussed later herein. Unsupervised model 140 may function as a classifier, a regression, or an anomaly detector for example. In some embodiments, unsupervised model 140 comprises at least one of a linear model, a reconstructive model, an artificial neural network, and/or a decision tree (e.g. in a forest model).

### Continuous Stream of Datapoints in Production Environment

Continuous feed 110 consists solely of a sequence of datapoints, including: a) datapoints not shown that computer 100 already processed and discarded, b) recent datapoints D1-D12 in sequence of recent batches 130 that computer 100 retains after processing, c) new datapoints D13-D16 in new batch 134 that is currently being processed during detected data drift, and d) datapoints not yet created or not yet received by computer 100.

Each datapoint may be a multidimensional point, where each dimension corresponds to a feature for machine learning. Data drift is a more or less long-term shift in the values distribution of a feature, and the shifted distribution no longer resembles the data distribution that unsupervised model 140 was already trained with. Data drift is detectable at least because it makes unsupervised model 140 more or less inaccurate until the data drift is mitigated by retraining as discussed later herein.

Each of datapoints D1-D16 may be individually received in sequence. For example, continuous feed 110 may be a live stream of data in a production environment. In various embodiments, each datapoint represents a distinct record or event. For example, each datapoint may be an entry in a log of a software application or computer that is currently executing.

### Batches of Datapoints

Each of batches 131-134 contains a same fixed count of datapoints, such as four as shown. Datapoints in datapoints 120 are shown with demonstrative zebra striping that alternates between bold and nonbold typeface to demonstratively indicate which batch is generated to contain which datapoints. For example, datapoints D1-D4 are shown bold to demonstratively indicate that they are contained in batch 131 that is shown bold. Likewise, datapoints D5-D8 are shown nonbold to demonstratively indicate that they are contained in batch 132 that is shown nonbold.

Herein, generation of a batch does not entail generation of a datapoint. Datapoints are received in continuous feed 110 as already generated. If continuous feed 110 is received over a communication network, then computer 100 does not generate datapoints.

As received, datapoints 120 are not already organized into sequence of recent batches 130. Computer 100 generates each of batches 131-133 individually and in sequence as sufficient datapoints arrive to populate a batch. In an ordering from left to right, datapoints 120 are individually received at distinct respective times such that datapoint D1 is received before any of datapoints D2- D16 are received. Batch 131 is dynamically generated to store datapoints D1-D4, and subsequent batch 132 is not generated until batch 131 is full.

Unsupervised model 140 processes one batch at a time in the ordering that the batches are generated. Unsupervised model 140 accepts one distinct datapoint in a batch at a time as an input that causes unsupervised model 140 to generate a respective inference (not shown). For example, unsupervised model 140 accepts each of four datapoints D1-D4 as a separate input to separately generate four respective inferences, and each inference may be more or less correct, which is measurable as discussed later herein.

### Unsupervised Model

Training or retraining of unsupervised model 140 entails unsupervised training and unsupervised loss measurement. In an embodiment, unsupervised model 140 is a reconstructive model that reconstructs its input while generating an inference, and unsupervised reconstruction loss measures the difference between the original input and the reconstructed input.

In an embodiment, unsupervised model 140 is a classifier or binary classifier (e.g. anomaly detector), and unsupervised loss is a minibatch loss for a minibatch of multiple datapoints, where minibatch loss is the difference between an expected frequency (e.g. contamination rate) of a class and the inferred frequency of the class in the minibatch. Minibatches are discussed below.

Because model 140 is unsupervised, all retraining and validation herein of unsupervised model 140 also is unsupervised. Any unsupervised ML activity herein does not require supervision labels and does not require human intervention (e.g. to provide labels). Thus herein, unsupervised also means full ML automation that never pauses for human labeling. Herein, unsupervised also means unlabeled datapoints, and supervised means labels or labeled datapoints. Labels, labeled datapoints, and supervision are not used herein. In some embodiments, any unsupervised ML activity herein may be implemented as self supervision or weak supervision.

### Each Batch Has Its Own Hyperparameter Value

For each of batches 131-133, unsupervised model 140 is respectively: a) reconfigured with a respective one of hyperparameter values 151-153 of a same hyperparameter and then b) retrained with a retraining corpus of recent batches, including those of batches 131-133 that are already generated. Recency of the batches in the retraining corpus is one of various ways herein that help mitigate data drift.

Herein, a batch is not the same as a training minibatch, although both contain a small subset of datapoints in a retraining corpus. The size of a training minibatch depends on machine learning hardware processor capacity. A batch herein may be referred to as a stream (i.e. feed) batch, and the size of a stream batch does not depend on machine learning hardware processor capacity. In an embodiment, a stream batch contains more datapoints than a minibatch contains.

As discussed later herein, a distinct hyperparameter value may be used for a particular batch or the hyperparameter value of the previous batch may be reused for the particular batch. For example, hyperparameter values 151-152 may or may not be identical. In the shown example, unsupervised model 140 has only one hyperparameter. Multiple hyperparameters are discussed later herein.

### Each Batch Has Its Own Retraining Corpus That Partially Overlaps Retraining Corpuses of Adjacent Batches

Herein, the retraining corpus for unsupervised model 140 consists of a fixed count of most recent batches, which effectively is a fixed-size retention buffer or sliding window of multiple whole batches. In an embodiment, all datapoints in the retraining corpus are stored together in a circular buffer. In the shown example, the retraining corpus consists of most recent batches 131-134. Although not shown, this same example earlier had not yet generated new batch 134, and the retraining corpus instead consisted of batches 131-133 and an older batch (not shown). When new batch 134 is generated, the older batch slides out of the window and becomes excluded from the retraining corpus, and new batch 134 becomes included in the retraining corpus.

Although the retraining corpus effectively is a truncated (i.e. age limited, i.e. most recent datapoints only) timeseries, the retraining corpus herein consists of multiple whole batches and is not the same as a state of the art timeseries that consists of some count of datapoints that is not an exact multiple of a batch size and thus does not consist of multiple whole batches. The retraining corpus herein is not the same as a sliding window whose stride (i.e. increment of sliding) is only a single datapoint. Sliding herein occurs between two retrainings and does not occur during one retraining. Thus, no individual retraining herein has a stride. Retraining herein always starts with an untrained unsupervised model 140 and fully trains unsupervised model 140. Thus, retraining herein is not a partial training such as pretraining or finetuning.

Herein, retraining recurs for each new batch when generated from continuous feed 110. Although retraining is caused by one new batch, the retraining corpus contains multiple recent batches. Thus a same batch may occur in multiple training corpuses in sequence for multiple retrainings in sequence until that batch slides out of the window as discussed above. Even though a recent batch may be reused in multiple retrainings, each batch has a hyperparameter value assigned to it only once, which is when the batch is generated.

For example when batch 133 is generated, it is a new batch for which hyperparameter value 153 is selected, and batch 134 does not yet exist. When batch 133 is generated, unsupervised model 140 is reconfigured with hyperparameter value 153 and retrained to achieve accuracy measurement 163, which is measured and recorded during unsupervised validation of unsupervised model 140 immediately after the retraining. Validation and validation acceleration are discussed later herein.

### Multivariate Timeseries Has Higher Dimensionality Than Retraining Corpus

Later as shown, new batch 134 is generated, which means that last batch 133 is no longer new. New hyperparameter value 154 is selected and used for retraining, and new accuracy measurement 164 is measured and recorded. However, last hyperparameter value 153 and last accuracy measurement 163 are retained as history. As shown, a respective hyperparameter value and a respective accuracy measurement are retained for each of batches 131-134 currently in the sliding window (i.e. current retraining corpus). Herein, the retraining corpus (i.e. batches 131-134) combined with hyperparameter values 151-154 and accuracy measurements 161-164 are effectively together one multivariate timeseries.

In this multivariate timeseries: a) each feature of the datapoints is a distinct independent variable and, because features occur in a feature vector (not shown) that unsupervised model 140 accepts as a whole input, each feature is an endogenous variable; b) hyperparameter values 151-154 are values of a same hyperparameter that is an independent variable that is an exogenous variable because it is not included in the feature vector that unsupervised model 140 accepts; and c) accuracy measurements 161-164 are values of a same accuracy metric that is the sole dependent variable in the multivariate timeseries.

### Acceleration From Mutually Exclusive Embodiments of Hyperparameter Estimation (I.E. Prediction)

Even though the hyperparameter is an independent variable, hyperparameter predictor 180 may predict (i.e. forecast) new hyperparameter value 154 when new batch 134 is generated. The following are three mutually exclusive embodiments of hyperparameter predictor 180, referred to herein as the least volatile embodiment, the fastest embodiment, and the balanced embodiment that achieves a so-called sweet spot that is a beneficial compromise between speed and volatility as discussed below.

The accuracy of these three embodiments are statistical over many retrainings and do not necessarily manifest during an individual retraining. For example, the fastest embodiment is fastest because it is the most accurate of the three embodiments as discussed later herein. Even though the fastest embodiment achieves the highest average accuracy of unsupervised model 140 over many retrainings, occasionally the fastest embodiment may have a retraining that is less accurate than one or both of the other embodiments of hyperparameter predictor 180. In any case, use of any of the three embodiments is faster than state of the art retraining as discussed later herein. The three embodiments of hyperparameter predictor 180 are as follows.

To decrease volatility of hyperparameter values, which decreases volatility of accuracy of unsupervised model 140, the least volatile embodiment of hyperparameter predictor 180 always reuses last hyperparameter value 153 as new hyperparameter value 154 that, as discussed later herein, does not mean that all of hyperparameter values 151-154 are identical. That is, and in any embodiment, hyperparameter values 151-154 may contain a mix of duplicate values and unique values. Likewise, even if hyperparameter values 151-152 are duplicates, respective accuracy measurements 161-162 usually are nonidentical because accuracy measurements 161-162 are based on respective retraining corpuses that are nonidentical because those retraining corpuses mostly, but not entirely (due to sliding), share recent batches.

To decreases volatility of hyperparameter and decreases volatility of accuracy values, the balanced embodiment of hyperparameter predictor 180 selects new hyperparameter value 154 as an average of multiple recent hyperparameter values 151-153.

The fastest embodiment of hyperparameter predictor 180 is a differencing algorithm that is not an ML model. A differencing algorithm is a timeseries algorithm that compares new values to old values. Unsupervised model 140 and the differencing algorithm accept distinct respective inputs. The differencing algorithm is a timeseries algorithm that accepts a whole or partial multivariate timeseries as input. In an embodiment, the differencing algorithm is Seasonal AutoRegressive Integrated Moving Average with Exogenous Regressors (SARIMAX) with default settings. In the multivariate timeseries, hyperparameter values 151-154 are values of a same hyperparameter that is both of: a) an autoregressive variable and b) as discussed above, an independent variable that is an exogenous variable.

### Accuracy Estimation for Acceleration

Herein, sampled fitness and exhaustive fitness are two kinds of accuracy measurements that both are unsupervised validation scores. Herein, exhaustive fitness is a measurement that is slow and highly accurate because it uses (e.g. folds of) a whole retraining corpus for retraining and validating.

Herein, sampled fitness is a measurement that is fast and somewhat inaccurate because it uses small strict subset 111 of datapoints that are randomly sampled without replacement from the retraining corpus for accelerated retraining and validating. Strict subset 111 contains some sampled datapoints from each of batches 131-134. That is, strict subset 111 is composed of a respective smaller constituent strict subset from each of batches 131-134.

Herein, sampled fitness may be referred to as estimated fitness, and exhaustive fitness may be referred to as actual fitness. The lifecycle of an accuracy measurement is as follows.

In the shown example, batch 134 and accuracy measurement 164 are new. Accuracy threshold 170 is a validation threshold that is a minimum estimated accuracy that should be achieved for new hyperparameter value 154 to pass validation. Herein are two kinds of retraining that are referred to as sampled retraining and unsampled retraining. Sampled retraining uses a small portion, as discussed above, of the retraining corpus and, immediately after sampled retraining, validation measures estimated fitness. Unsampled retraining uses the whole retraining corpus and, immediately after unsampled retraining, validation measures actual fitness.

Initially: 1) unsupervised model 140 is configured with new hyperparameter value 154, then 2) unsupervised model 140 is quickly sampled retrained, and then 3) new accuracy measurement 164 is quickly measured as an estimated fitness. For acceleration, this does not entail (i.e. iterative) hyperparameter tuning as discussed later herein, which would be slow.

Only if accuracy threshold 170 does not exceed estimated new accuracy measurement 164, then new hyperparameter value 154 passes validation and: 1) unsupervised model 140 is again configured with new hyperparameter value 154, then 2) unsupervised model 140 is unsampled retrained, and then 3) new accuracy measurement 164 is remeasured as an actual fitness, and the estimated fitness is discarded. For acceleration, this also does not entail (i.e. iterative) hyperparameter tuning.

### Conditional Acceleration of ML Pipeline

As follows, computer 100 contains a full ML pipeline (not shown) that contains a sequence of multiple distinct stages, the last of which is unsampled retraining, including validation to measure actual fitness. If new hyperparameter value 154 passes validation then, for acceleration, only that last stage occurs.

When the last stage occurs, then the batch’s retained accuracy measurement is an actual fitness. All actual fitness herein is measured by the last stage.

If accuracy threshold instead exceeds estimated new accuracy measurement 164, then new hyperparameter value 154 fails validation, and the whole (i.e. all stages) ML pipeline executes, which may entail a sequence of stages such as: model selection, then feature selection, then slow iterative hyperparameter tuning to discover another new and better (i.e. tuned) hyperparameter value, and then unsampled retraining in the last stage. Iterative hyperparameter tuning is the preceding stage that is adjacent to the last stage, and this next to last stage is by far the slowest stage and slower than the model selection stage and feature selection stage combined. For that reason and to increase accuracy of unsupervised model 140, the whole ML pipeline is executed when validation of new hyperparameter value 154 fails.

If the whole pipeline executes, then the tuned hyperparameter value is recorded as (i.e. overwrites the predicted value from hyperparameter predictor 180) new hyperparameter value 154, and the tuned accuracy is an actual fitness that is recorded as (i.e. overwrites the estimated) new accuracy measurement 164. In other words in the shown example, all of recent hyperparameter values 151-153 already passed validation. Likewise, all of recent accuracy measurements 161-163 are actual fitness.

Because retraining and validation of model 140 is unsupervised, computer 100 can receive, process, and retrain for new batches more or less continuously (i.e. without requiring administration or scheduling). For example, continuous feed 110 may be more or less infinitely long and experience data drift at seasonal, arbitrary, or numerous times without ever causing unsupervised model 140 to become unusable. Thus, unsupervised model 140 may always be online and never out of service, which is continuous operation.

### Multiple Hyperparameters

In an embodiment, unsupervised model 140 is a principal component analysis (PCA, discussed later herein) that has only one hyperparameter, which is a component count. In an embodiment, unsupervised model 140 has multiple hyperparameters, and each batch in the current retraining corpus has a separate value for each hyperparameter. For example, a PCA embodiment may have one, two, or three hyperparameters such as component count, whitening flag, and solver algorithm.

In an embodiment, there is a separate hyperparameter predictor 180 respectively for each hyperparameter. Even when multiple distinct hyperparameter predictors 180 are used to predict respective values for multiple hyperparameters, there still is only one sampled retraining and validation that generates one estimated fitness that is a single estimated new accuracy measurement 164, and only one unsampled retraining and validation that generates one actual fitness that is a single actual new accuracy measurement 164.

In the fastest embodiment discussed earlier herein, there is a separate hyperparameter predictor 180 (e.g. SARIMAX) for each hyperparameter. That is, each distinct hyperparameter is a distinct autoregressive variable, and each SARIMAX supports only one autoregressive variable.

As discussed earlier herein, the first stage in the whole ML pipeline is model selection that selects from multiple model types such as a forest model or a neural model that are described later herein. Any hyperparameter predictor 180 herein is only configured (e.g. trained) for predicting for one model type. For example, there may be only two model types, which respectively have one and two hyperparameters. In that case, computer 100 either has: a) 2 + 1 = three distinct instances of hyperparameter predictor 180 (e.g. metamodel or not) and does not use all of them for a same current ML model 140 or b) two multi-hyperparameter metamodels that each is for a respective one of the two model types. For example at various times, computer 100 may switch between multiple model types over the lifespan of continuous feed 110. For example, detected data drift may cause execution of the whole ML pipeline as discussed earlier herein, including the first stage, which is model selection.

Due to model selection, the current retraining corpus may contain a mix of batches whose hyperparameter values are for different respective model types. In an embodiment, hyperparameter predictor 180 is not used when the current retraining corpus contains batches for different model types. In that case, the whole ML pipeline is used for every new batch until, due to sliding, the current retraining corpus no longer contains batches of different model types. Even when the whole ML pipeline is used instead of or in addition to hyperparameter predictor 180, new values 154 and 164 are always generated and recorded.

### EXAMPLE ACCELERATED RETRAINING PROCESS

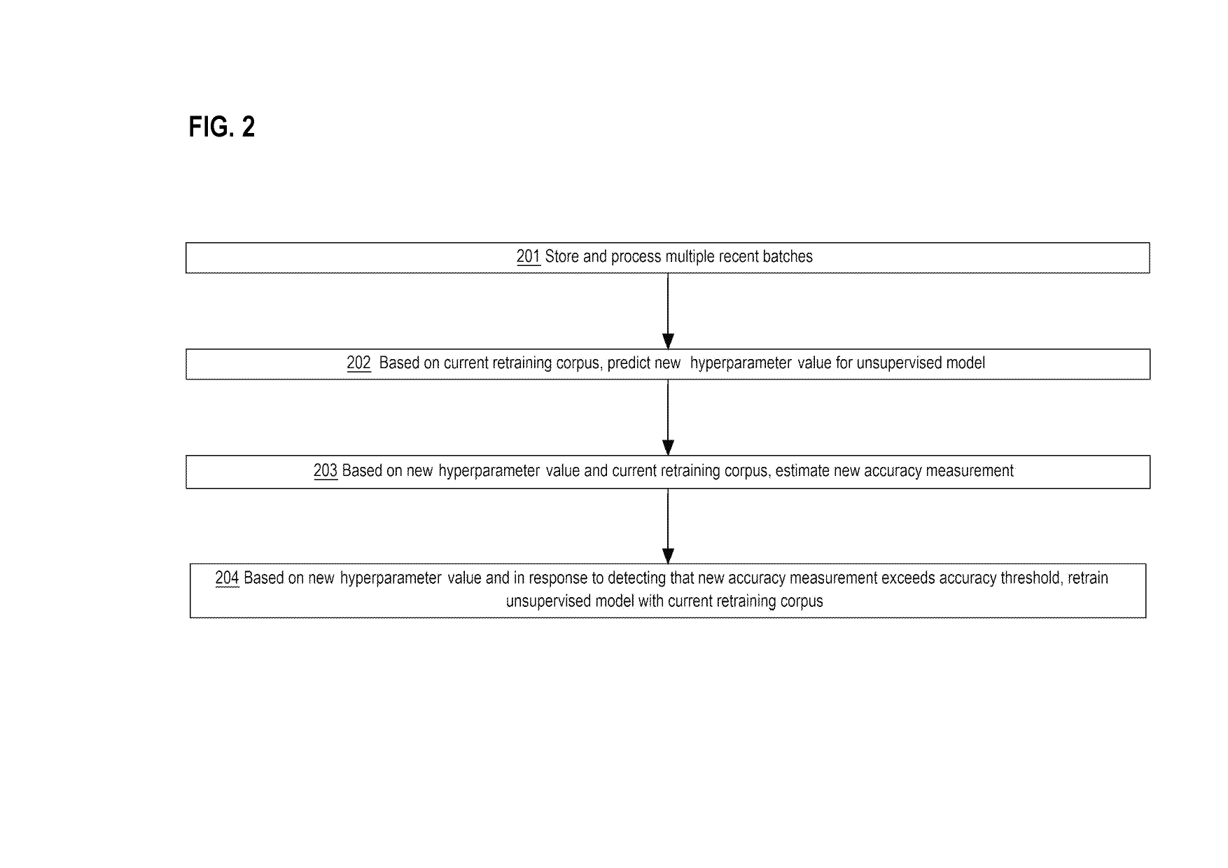

FIG. 2 is a flow diagram that depicts an example process that computer 100 may perform for new batch 134 of new datapoints D13-D16 during a detected data drift in continuous feed 110, and this process noniteratively selects a new hyperparameters configuration that includes new hyperparameter value 154 to accelerate generating a retrained unsupervised model 140 without decreasing new accuracy measurement 164 nor increasing volatility of new accuracy measurement 164. The process of FIG. 2 begins before data drift occurs.

Step 201 stores and processes sequence of recent batches 130 as discussed earlier herein. Data drift occurs during step 201. Between steps 201-202 the data drift is detected.

Step 202 is a reaction to detection of data drift. Based on the current retraining corpus in step 202, hyperparameter predictor 180 predicts new hyperparameter value 154, and a single predicting in step 202 is noniterative and is not hyperparameter tuning, as discussed earlier herein.

In step 203, new hyperparameter value 154 passes validation. Based on new hyperparameter value 154, step 203 sampled retrains unsupervised model 140 with the current retraining corpus as discussed earlier herein. Step 203 estimates new accuracy measurement 164 and detects that accuracy threshold 170 does not exceed estimated new accuracy measurement 164.

In an embodiment, step 203 uses last accuracy measurement 163 as accuracy threshold 170. In that case, validation of new hyperparameter value 154 fails if accuracy is decreasing (i.e. last hyperparameter value 153 was more accurate), and this failure causes execution of the whole ML pipeline as discussed elsewhere herein. Herein, execution of the whole ML pipeline always maximizes accuracy of unsupervised model 140.

Based on new hyperparameter value 154, step 204 unsampled retrains unsupervised model 140 with the current retraining corpus. Without decreasing accuracy of unsupervised model 140, the process of FIG. 1 is an order of magnitude faster than executing the whole ML pipeline. For example, the process of FIG. 1 and the whole ML pipeline may be distinct ways in which, in many cases and even though the process of FIG. 1 is much faster, either way might generate the exact same retrained model.

The following is an enumeration of some ML activities A-H that might occur in a state of the art ML pipeline. The process of FIG. 2 demonstrates execution of less than a whole ML pipeline for acceleration. As discussed later herein: a) steps 202-204 may be in reaction to detecting data drift; b) data drift may recur; and c) because how much of the ML pipeline should execute depends on various conditions herein, some ML pipeline stages may execute for one data drift but not for another data drift. Thus two data drifts may be handled differently with different behaviors. Additionally, the many embodiments elsewhere herein may further have different behaviors and mechanisms. Although some embodiments herein may perform some of these enumerated ML activities conditionally or always, some embodiments herein may handle a particular data drift in a way that performs none of these enumerated ML activities A-H. For example, execution of less than a whole ML pipeline may entail fewer activities, and some embodiments never perform some activities. The state of the art cannot handle an individual data drift in any way that performs none of these enumerated ML activities A-H. That is, every state of the art reaction to detected data drift always entails at least one of these enumerated ML activities A-H.

A. Generation of more than one estimated new accuracy measurement for new batch 134.

B. Storage of a metafeature value. A metafeature is a statistic of continuous feed 110 or of any sequence of datapoints, such as a value range for a feature.

C. Operation of a metamodel. A metamodel is an additional ML model that accepts input that is performance data that characterizes unsupervised model 140.

D. Metalearning is training a metamodel.

E. Finetuning is retraining that does not start with an untrained unsupervised model 140.

F. Operation of an ensemble model. An ensemble model is an ML model that is a composite (e.g. forest) of multiple other ML models (e.g. weak learners).

G. Operation of a decision tree (e.g. as a weak learner).

H. Boosting is ensemble training with weak learners.

### EXAMPLE RECURRING DRIFT PROCESS

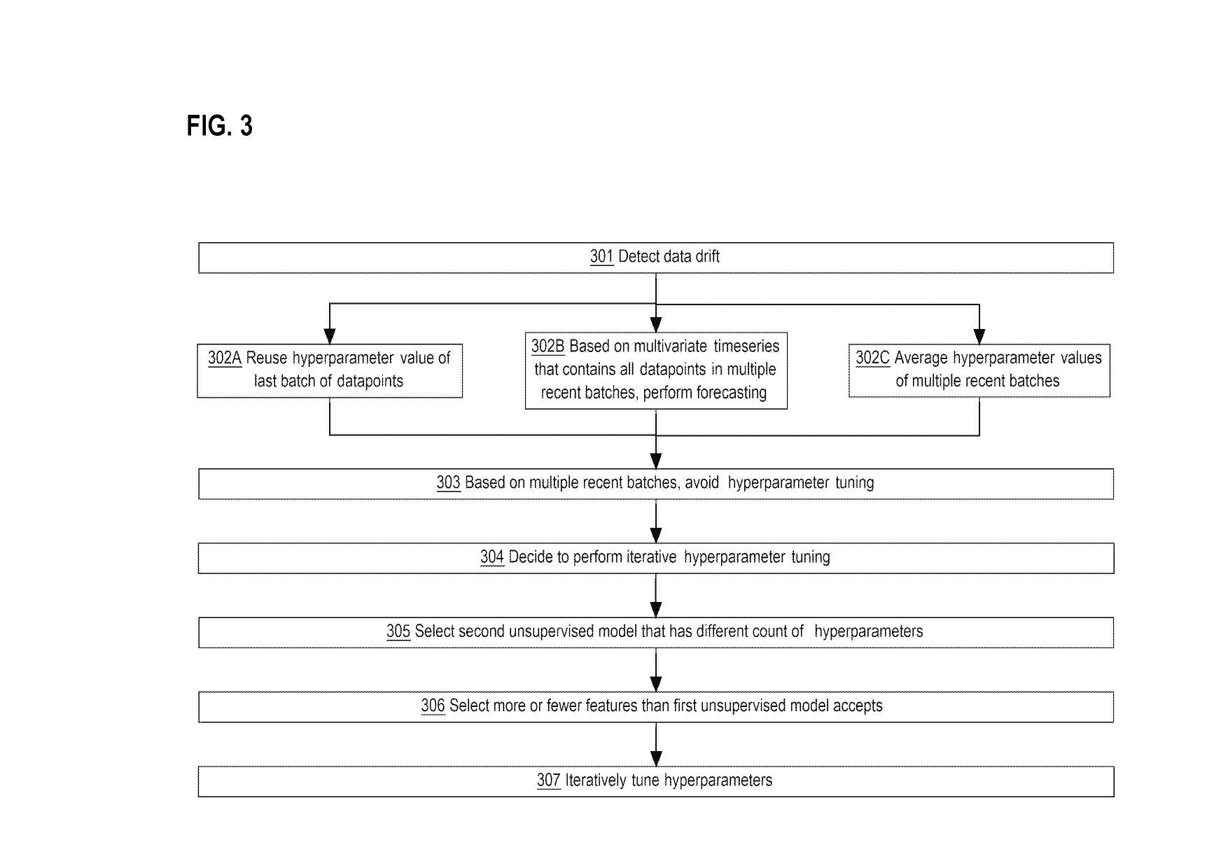

As discussed above, steps 202-204 in FIG. 2 are a reaction to data drift. This reaction can be repeated because data drift may recur. FIG. 3 is a flow diagram that depicts an example process that computer 100 may perform that handles recurring data drift. FIG. 3 handles two data drifts in different respective ways to demonstrate the flexibility of the approach herein.

The processes of FIGS. 2-3 may be combined into a combined process. Step 301 in FIG. 3 occurs between steps 201-202 in FIG. 2. Step 301 detects data drift in continuous feed 110. In an embodiment, this detection entails monitoring and thresholding the accuracy of unsupervised model 140. In various embodiments, drift detection by step 301 may entail monitoring the results of processing a sequence of multiple datapoints in one batch or a sequence of multiple batches (i.e. retrainings).

As discussed earlier herein, the fastest embodiment, the least volatile embodiment, and the balanced embodiment are three mutually exclusive embodiments of hyperparameter predictor 180 that are implemented by respective steps 302A-C. That is, embodiments of computer 100 implement and perform only one of steps 302A-C. Steps 302A-C are implementations of step 202 in FIG. 2.

In step 302A, the least volatile embodiment of hyperparameter predictor 180 reuses last hyperparameter value 153 as new hyperparameter value 154.

Based on a multivariate timeseries that contains the current training corpus in step 302B, the fastest embodiment of hyperparameter predictor 180 forecasts new hyperparameter value 154. For example, step 302B may treat the hyperparameter as an autoregressive variable such as with Seasonal AutoRegressive Integrated Moving Average with Exogenous Regressors (SARIMAX).

In step 302C, the balanced embodiment of hyperparameter predictor 180 averages the hyperparameter values of all batches in sequence of recent batches 130.

Step 303 is a sub-step of step 204 in FIG. 2. When step 204 detects that new hyperparameter value 154 passes validation, step 204 executes only the last stage (i.e. unsampled retraining) instead of all stages of the ML pipeline. This entails step 303 that, due to passed validation and execution of only the last stage, avoids (i.e. iterative) hyperparameter tuning that only executes if the whole ML pipeline executes.

Steps 301-303 are one way to handle one data drift which, for acceleration, is a way without hyperparameter tuning. Steps 304-305 are a different way that entails hyperparameter tuning, and both ways are conditional and mutually exclusive. In this example is a second data drift that, between steps 303-304, occurs and is detected, which causes the following reaction. Between steps 303-304, much time may elapse and many batches may slide out of recent sequence of recent batches 130 before data drift recurs.

Between steps 303-304, steps 301 and 201-203 in FIG. 2 are repeated for the second data drift. With the first data drift, step 203 passed validation. With the second data drift, step 203 instead fails validation because estimated new accuracy measurement 164 is too low. This failure causes falling back to using the whole ML pipeline for new batch 134, which entails steps 304-306. That is, step 304 decides to execute the whole ML pipeline, and this decision will cause iterative hyperparameter tuning in a later step below.

In step 305, the model selection stage of the ML pipeline selects a different model type than unsupervised model 140. In this example, step 304 selects a second unsupervised model that has a different count of hyperparameters than unsupervised model 140.

In step 306, the feature selection stage of the ML pipeline selects more or fewer features than unsupervised model 140 accepts. That is, the second unsupervised model and unsupervised model 140 expect different subsets of features that are available in each datapoint. Likewise, the second unsupervised model and unsupervised model 140 accept feature vectors of different respective sizes (e.g. count of features and/or count of bytes).

In step 307, the hyperparameter tuning stage iteratively operates to discover a better new hyperparameter value 154. After step 307, the last stage occurs, which is unsampled retraining of unsupervised model 140.

After executing the whole ML pipeline for the second data drift, the training corpus will contain a mix of batches that were processed with the second unsupervised model or unsupervised model 140 that have different model types. In an embodiment discussed earlier herein, hyperparameter predictor 180 is not used when the current retraining corpus contains batches for different model types. In that case, the whole ML pipeline is used for every new batch until, due to sliding, the current retraining corpus no longer contains batches of different model types.

### HARDWARE OVERVIEW

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

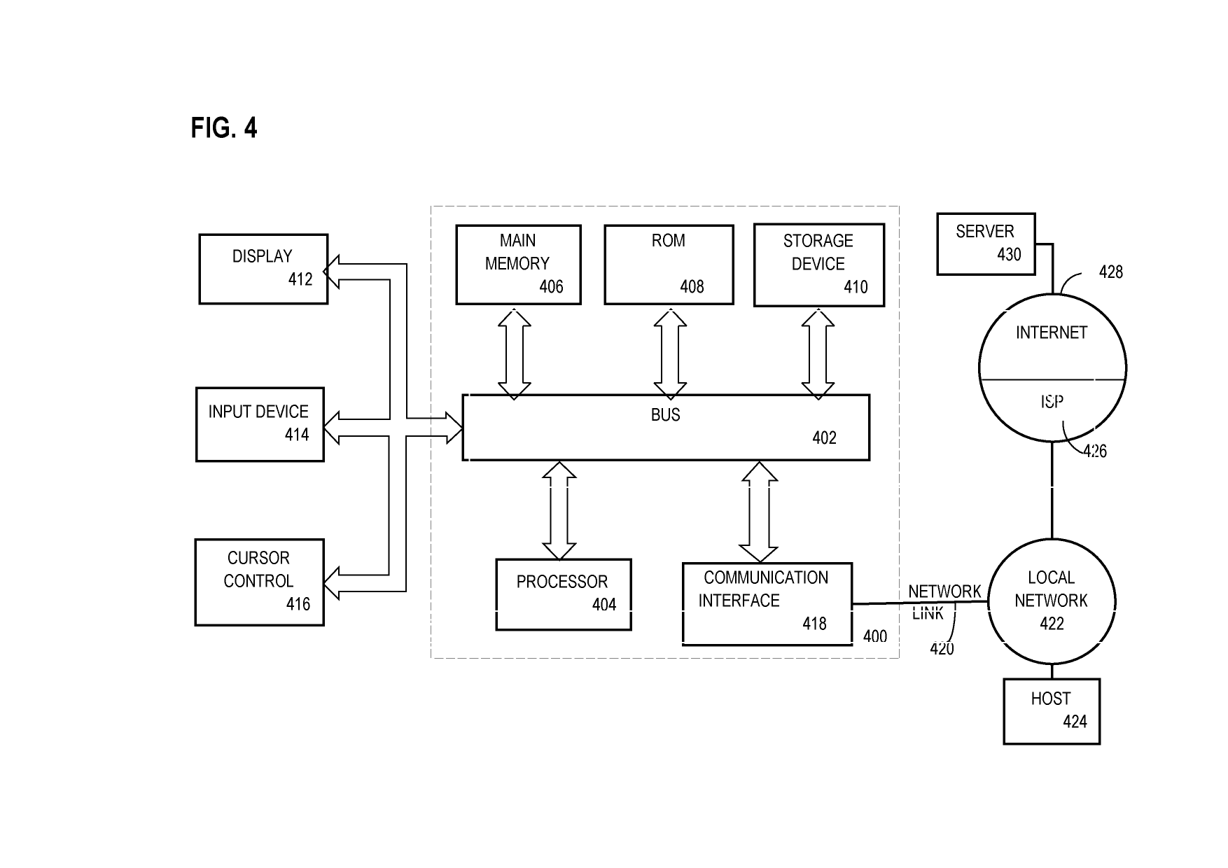

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or solid-state drive is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 410. Volatile media includes dynamic memory, such as main memory 406. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

### SOFTWARE OVERVIEW

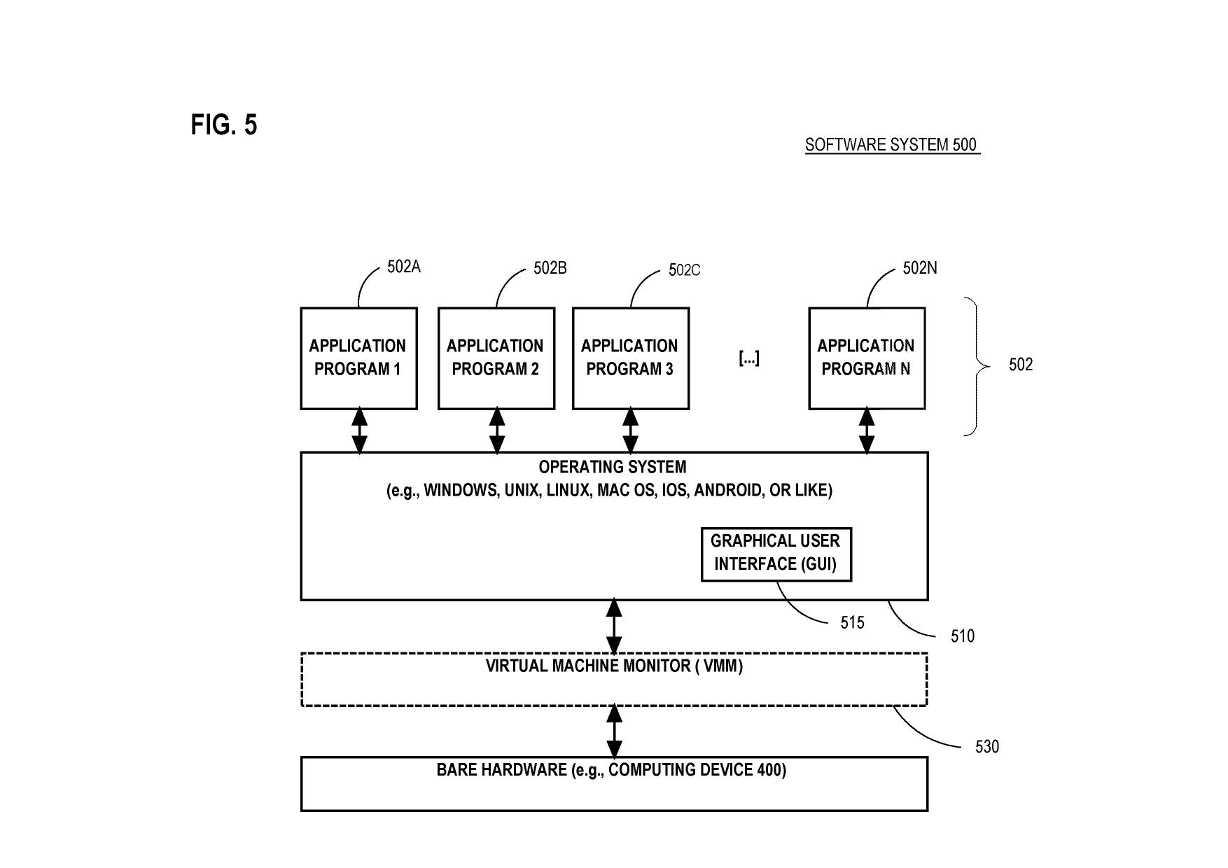

FIG. 5 is a block diagram of a basic software system 500 that may be employed for controlling the operation of computing system 400. Software system 500 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 500 is provided for directing the operation of computing system 400. Software system 500, which may be stored in system memory (RAM) 406 and on fixed storage (e.g., hard disk or flash memory) 410, includes a kernel or operating system (OS) 510.

The OS 510 manages low-level aspects of computer operation, including managing execution of processes, memory allocation, file input and output (I/O), and device I/O. One or more application programs, represented as 502A, 502B, 502C … 502N, may be “loaded” (e.g., transferred from fixed storage 410 into memory 406) for execution by the system 500. The applications or other software intended for use on computer system 400 may also be stored as a set of downloadable computer-executable instructions, for example, for downloading and installation from an Internet location (e.g., a Web server, an app store, or other online service).

Software system 500 includes a graphical user interface (GUI) 515, for receiving user commands and data in a graphical (e.g., “point-and-click” or “touch gesture”) fashion. These inputs, in turn, may be acted upon by the system 500 in accordance with instructions from operating system 510 and/or application(s) 502. The GUI 515 also serves to display the results of operation from the OS 510 and application(s) 502, whereupon the user may supply additional inputs or terminate the session (e.g., log off).

OS 510 can execute directly on the bare hardware 520 (e.g., processor(s) 404) of computer system 400. Alternatively, a hypervisor or virtual machine monitor (VMM) 530 may be interposed between the bare hardware 520 and the OS 510. In this configuration, VMM 530 acts as a software “cushion” or virtualization layer between the OS 510 and the bare hardware 520 of the computer system 400.

VMM 530 instantiates and runs one or more virtual machine instances (“guest machines”). Each guest machine comprises a “guest” operating system, such as OS 510, and one or more applications, such as application(s) 502, designed to execute on the guest operating system. The VMM 530 presents the guest operating systems with a virtual operating platform and manages the execution of the guest operating systems.

In some instances, the VMM 530 may allow a guest operating system to run as if it is running on the bare hardware 520 of computer system 400 directly. In these instances, the same version of the guest operating system configured to execute on the bare hardware 520 directly may also execute on VMM 530 without modification or reconfiguration. In other words, VMM 530 may provide full hardware and CPU virtualization to a guest operating system in some instances.

In other instances, a guest operating system may be specially designed or configured to execute on VMM 530 for efficiency. In these instances, the guest operating system is “aware” that it executes on a virtual machine monitor. In other words, VMM 530 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

### CLOUD COMPUTING

The term "cloud computing" is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprise two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure and applications.

The above-described basic computer hardware and software and cloud computing environment presented for purpose of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### MACHINE LEARNING MODELS

A machine learning model is trained using a particular machine learning algorithm. Once trained, input is applied to the machine learning model to make a prediction, which may also be referred to herein as a predicated output or output. Attributes of the input may be referred to as features and the values of the features may be referred to herein as feature values.

A machine learning model includes a model data representation or model artifact. A model artifact comprises parameters values, which may be referred to herein as theta values, and which are applied by a machine learning algorithm to the input to generate a predicted output. Training a machine learning model entails determining the theta values of the model artifact. The structure and organization of the theta values depends on the machine learning algorithm.

In supervised training, training data is used by a supervised training algorithm to train a machine learning model. The training data includes input and a “known” output. In an embodiment, the supervised training algorithm is an iterative procedure. In each iteration, the machine learning algorithm applies the model artifact and the input to generate a predicated output. An error or variance between the predicated output and the known output is calculated using an objective function. In effect, the output of the objective function indicates the accuracy of the machine learning model based on the particular state of the model artifact in the iteration. By applying an optimization algorithm based on the objective function, the theta values of the model artifact are adjusted. An example of an optimization algorithm is gradient descent. The iterations may be repeated until a desired accuracy is achieved or some other criteria is met.

In a software implementation, when a machine learning model is referred to as receiving an input, being executed, and/or generating an output or predication, a computer system process executing a machine learning algorithm applies the model artifact against the input to generate a predicted output. A computer system process executes a machine learning algorithm by executing software configured to cause execution of the algorithm. When a machine learning model is referred to as performing an action, a computer system process executes a machine learning algorithm by executing software configured to cause performance of the action.

Inferencing entails a computer applying the machine learning model to an input such as a feature vector to generate an inference by processing the input and content of the machine learning model in an integrated way. Inferencing is data driven according to data, such as learned coefficients, that the machine learning model contains. Herein, this is referred to as inferencing by the machine learning model that, in practice, is execution by a computer of a machine learning algorithm that processes the machine learning model.

Classes of problems that machine learning (ML) excels at include clustering, classification, regression, anomaly detection, prediction, and dimensionality reduction (i.e. simplification). Examples of machine learning algorithms include decision trees, support vector machines (SVM), Bayesian networks, stochastic algorithms such as genetic algorithms (GA), and connectionist topologies such as artificial neural networks (ANN). Implementations of machine learning may rely on matrices, symbolic models, and hierarchical and/or associative data structures. Parameterized (i.e. configurable) implementations of best of breed machine learning algorithms may be found in open source libraries such as Google’s TensorFlow for Python and C++ or Georgia Institute of Technology’s MLPack for C++. Shogun is an open source C++ ML library with adapters for several programing languages including C#, Ruby, Lua, Java, MatLab, R, and Python.

### ARTIFICIAL NEURAL NETWORKS

An artificial neural network (ANN) is a machine learning model that at a high level models a system of neurons interconnected by directed edges. An overview of neural networks is described within the context of a layered feedforward neural network. Other types of neural networks share characteristics of neural networks described below.

In a layered feed forward network, such as a multilayer perceptron (MLP), each layer comprises a group of neurons. A layered neural network comprises an input layer, an output layer, and one or more intermediate layers referred to hidden layers.

Neurons in the input layer and output layer are referred to as input neurons and output neurons, respectively. A neuron in a hidden layer or output layer may be referred to herein as an activation neuron. An activation neuron is associated with an activation function. The input layer does not contain any activation neuron.

From each neuron in the input layer and a hidden layer, there may be one or more directed edges to an activation neuron in the subsequent hidden layer or output layer. Each edge is associated with a weight. An edge from a neuron to an activation neuron represents input from the neuron to the activation neuron, as adjusted by the weight.

For a given input to a neural network, each neuron in the neural network has an activation value. For an input neuron, the activation value is simply an input value for the input. For an activation neuron, the activation value is the output of the respective activation function of the activation neuron.

Each edge from a particular neuron to an activation neuron represents that the activation value of the particular neuron is an input to the activation neuron, that is, an input to the activation function of the activation neuron, as adjusted by the weight of the edge. Thus, an activation neuron in the subsequent layer represents that the particular neuron’s activation value is an input to the activation neuron’s activation function, as adjusted by the weight of the edge. An activation neuron can have multiple edges directed to the activation neuron, each edge representing that the activation value from the originating neuron, as adjusted by the weight of the edge, is an input to the activation function of the activation neuron.

Each activation neuron is associated with a bias. To generate the activation value of an activation neuron, the activation function of the neuron is applied to the weighted activation values and the bias.

### ILLUSTRATIVE DATA STRUCTURES FOR NEURAL NETWORK

The artifact of a neural network may comprise matrices of weights and biases. Training a neural network may iteratively adjust the matrices of weights and biases.

For a layered feedforward network, as well as other types of neural networks, the artifact may comprise one or more matrices of edges W. A matrix W represents edges from a layer L-1 to a layer L. Given the number of neurons in layer L-1 and L is N[L-1] and N[L], respectively, the dimensions of matrix W is N[L-1] columns and N[L] rows.

Biases for a particular layer L may also be stored in matrix B having one column with N[L] rows.

The matrices W and B may be stored as a vector or an array in RAM memory, or comma separated set of values in memory. When an artifact is persisted in persistent storage, the matrices W and B may be stored as comma separated values, in compressed and/serialized form, or other suitable persistent form.

A particular input applied to a neural network comprises a value for each input neuron. The particular input may be stored as vector. Training data comprises multiple inputs, each being referred to as sample in a set of samples. Each sample includes a value for each input neuron. A sample may be stored as a vector of input values, while multiple samples may be stored as a matrix, each row in the matrix being a sample.

When an input is applied to a neural network, activation values are generated for the hidden layers and output layer. For each layer, the activation values for may be stored in one column of a matrix A having a row for every neuron in the layer. In a vectorized approach for training, activation values may be stored in a matrix, having a column for every sample in the training data.

Training a neural network requires storing and processing additional matrices. Optimization algorithms generate matrices of derivative values which are used to adjust matrices of weights W and biases B. Generating derivative values may use and require storing matrices of intermediate values generated when computing activation values for each layer.

The number of neurons and/or edges determines the size of matrices needed to implement a neural network. The smaller the number of neurons and edges in a neural network, the smaller matrices and amount of memory needed to store matrices. In addition, a smaller number of neurons and edges reduces the amount of computation needed to apply or train a neural network. Less neurons means less activation values need be computed, and/or less derivative values need be computed during training.

Properties of matrices used to implement a neural network correspond neurons and edges. A cell in a matrix W represents a particular edge from a neuron in layer L-1 to L. An activation neuron represents an activation function for the layer that includes the activation function. An activation neuron in layer L corresponds to a row of weights in a matrix W for the edges between layer L and L-1 and a column of weights in matrix W for edges between layer L and L+1. During execution of a neural network, a neuron also corresponds to one or more activation values stored in matrix A for the layer and generated by an activation function.

An ANN is amenable to vectorization for data parallelism, which may exploit vector hardware such as single instruction multiple data (SIMD), such as with a graphical processing unit (GPU). Matrix partitioning may achieve horizontal scaling such as with symmetric multiprocessing (SMP) such as with a multicore central processing unit (CPU) and or multiple coprocessors such as GPUs. Feed forward computation within an ANN may occur with one step per neural layer. Activation values in one layer are calculated based on weighted propagations of activation values of the previous layer, such that values are calculated for each subsequent layer in sequence, such as with respective iterations of a for loop. Layering imposes sequencing of calculations that is not parallelizable. Thus, network depth (i.e. amount of layers) may cause computational latency. Deep learning entails endowing a multilayer perceptron (MLP) with many layers. Each layer achieves data abstraction, with complicated (i.e. multidimensional as with several inputs) abstractions needing multiple layers that achieve cascaded processing. Reusable matrix based implementations of an ANN and matrix operations for feed forward processing are readily available and parallelizable in neural network libraries such as Google’s TensorFlow for Python and C++, OpenNN for C++, and University of Copenhagen’s fast artificial neural network (FANN). These libraries also provide model training algorithms such as backpropagation.

### BACKPROPAGATION

An ANN’s output may be more or less correct. For example, an ANN that recognizes letters may mistake an I as an L because those letters have similar features. Correct output may have particular value(s), while actual output may have somewhat different values. The arithmetic or geometric difference between correct and actual outputs may be measured as error according to a loss function, such that zero represents error free (i.e. completely accurate) behavior. For any edge in any layer, the difference between correct and actual outputs is a delta value.

Backpropagation entails distributing the error backward through the layers of the ANN in varying amounts to all of the connection edges within the ANN. Propagation of error causes adjustments to edge weights, which depends on the gradient of the error at each edge. Gradient of an edge is calculated by multiplying the edge’s error delta times the activation value of the upstream neuron. When the gradient is negative, the greater the magnitude of error contributed to the network by an edge, the more the edge’s weight should be reduced, which is negative reinforcement. When the gradient is positive, then positive reinforcement entails increasing the weight of an edge whose activation reduced the error. An edge weight is adjusted according to a percentage of the edge’s gradient. The steeper is the gradient, the bigger is adjustment. Not all edge weights are adjusted by a same amount. As model training continues with additional input samples, the error of the ANN should decline. Training may cease when the error stabilizes (i.e. ceases to reduce) or vanishes beneath a threshold (i.e. approaches zero). Example mathematical formulae and techniques for feedforward multilayer perceptron (MLP), including matrix operations and backpropagation, are taught in related reference “EXACT CALCULATION OF THE HESSIAN MATRIX FOR THE MULTI-LAYER PERCEPTRON,” by Christopher M. Bishop.

Model training may be supervised or unsupervised. For supervised training, the desired (i.e. correct) output is already known for each example in a training set. The training set is configured in advance by (e.g. a human expert) assigning a categorization label to each example. For example, the training set for optical character recognition may have blurry photographs of individual letters, and an expert may label each photo in advance according to which letter is shown. Error calculation and backpropagation occurs as explained above.

### AUTOENCODER

Unsupervised model training is more involved because desired outputs need to be discovered during training. Unsupervised training may be easier to adopt because a human expert is not needed to label training examples in advance. Thus, unsupervised training saves human labor. A natural way to achieve unsupervised training is with an autoencoder, which is a kind of ANN. An autoencoder functions as an encoder/decoder (codec) that has two sets of layers. The first set of layers encodes an input example into a condensed code that needs to be learned during model training. The second set of layers decodes the condensed code to regenerate the original input example. Both sets of layers are trained together as one combined ANN. Error is defined as the difference between the original input and the regenerated input as decoded. After sufficient training, the decoder outputs more or less exactly whatever is the original input.

An autoencoder relies on the condensed code as an intermediate format for each input example. It may be counter-intuitive that the intermediate condensed codes do not initially exist and instead emerge only through model training. Unsupervised training may achieve a vocabulary of intermediate encodings based on features and distinctions of unexpected relevance. For example, which examples and which labels are used during supervised training may depend on somewhat unscientific (e.g. anecdotal) or otherwise incomplete understanding of a problem space by a human expert. Whereas, unsupervised training discovers an apt intermediate vocabulary based more or less entirely on statistical tendencies that reliably converge upon optimality with sufficient training due to the internal feedback by regenerated decodings. Techniques for unsupervised training of an autoencoder for anomaly detection based on reconstruction error is taught in non-patent literature (NPL) “VARIATIONAL AUTOENCODER BASED ANOMALY DETECTION USING RECONSTRUCTION PROBABILITY”, Special Lecture on IE. 2015 Dec 25;2(1):1-18 by Jinwon An et al.

### PRINCIPAL COMPONENT ANALYSIS

Principal component analysis (PCA) provides dimensionality reduction by leveraging and organizing mathematical correlation techniques such as normalization, covariance, eigenvectors, and eigenvalues. PCA incorporates aspects of feature selection by eliminating redundant features. PCA can be used for prediction. PCA can be used in conjunction with other ML algorithms.

### RANDOM FOREST

A random forest or random decision forest is an ensemble of learning approaches that construct a collection of randomly generated nodes and decision trees during a training phase. Different decision trees of a forest are constructed to be each randomly restricted to only particular subsets of feature dimensions of the data set, such as with feature bootstrap aggregating (bagging). Therefore, the decision trees gain accuracy as the decision trees grow without being forced to over fit training data as would happen if the decision trees were forced to learn all feature dimensions of the data set. A prediction may be calculated based on a mean (or other integration such as soft max) of the predictions from the different decision trees.

Random forest hyper-parameters may include: number-of-trees-in-the-forest, maximum-number-of-features-considered-for-splitting-a-node, number-of-levels-in-each-decision-tree, minimum-number-of-data-points-on-a-leaf-node, method-for-sampling-data-points, etc.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
storing for each batch in a sequence of batches of datapoints that includes a last batch of datapoints:
the batch,
a hyperparameter value for an unsupervised model, and
an accuracy measurement, for the unsupervised model, that is based on both of the hyperparameter value and the batch;
predicting, based on a plurality of batches that contains a batch of new datapoints and the batches in the sequence of batches of datapoints, a new hyperparameter value for the unsupervised model;
estimating, based on the plurality of batches, a new accuracy measurement that is based on the new hyperparameter value; and
training, based on the new hyperparameter value and in response to detecting that the new accuracy measurement exceeds an accuracy threshold, the unsupervised model with the plurality of batches.

2. The method of claim 1 wherein:
the sequence of batches of datapoints includes an other batch that is not the last batch of datapoints;
said predicting the new hyperparameter value comprises averaging a plurality of hyperparameter values that includes the hyperparameter value for the last batch and the hyperparameter value for the other batch.

3. The method of claim 1 further comprising avoiding, in response to said detecting, hyperparameter tuning based on the corpus of batches.

4. The method of claim 1 wherein said estimating is based on a strict subset of the datapoints in the plurality of batches that contains a strict subset of the new datapoints.

5. The method of claim 1 wherein said predicting the new hyperparameter value comprises reusing the hyperparameter value for the last batch of datapoints.

6. The method of claim 1 wherein said predicting the new hyperparameter value comprises forecasting based on a timeseries that contains the datapoints in the sequence of batches of datapoints.

7. The method of claim 1 further comprising based on the new hyperparameter value and the plurality of batches, performing at least one machine learning activity selected from a group consisting of:
a model selection of a second unsupervised model that does not have a same count of hyperparameters as said unsupervised model,
a feature selection of a more or fewer features than said unsupervised model accepts, and
a decision to perform iterative hyperparameter tuning of said unsupervised model.

8. The method of claim 1 wherein said predicting the new hyperparameter value is in response to detecting data drift.

9. The method of claim 1 wherein said predicting the new hyperparameter value is noniterative.

10. The method of claim 1 wherein the accuracy threshold is based on the accuracy measurement of the last batch of datapoints.

11. The method of claim 1 without comprising at least one machine learning activity selected from a group consisting of:
generation of a second new accuracy measurement that is based on the batch of new datapoints,
storage of a metafeature value,
operation of a metamodel,
performance of metalearning,
performance of finetuning,
operation of an ensemble model,
operation of a decision tree, and
performance of boosting.

12. The method of claim 1 further comprising:
measuring the new accuracy measurement after said training;
unsupervised performing at least one machine learning activity selected from a group consisting of said training and said measuring.

13. The method of claim 1 wherein the unsupervised model comprises at least one selected from a group consisting of: a linear model, a reconstructive model, an artificial neural network, and a decision tree.

14. The method of claim 1 wherein a sliding window of batches consists of the plurality of batches.

15. One or more non-transitory computer-readable media storing instructions that, when executed by one or more processors, cause:
storing for each batch in a sequence of batches of datapoints that includes a last batch of datapoints:
the batch,
a hyperparameter value for an unsupervised model, and
an accuracy measurement, for the unsupervised model, that is based on both of the hyperparameter value and the batch;
predicting, based on a plurality of batches that contains a batch of new datapoints and the batches in the sequence of batches of datapoints, a new hyperparameter value for the unsupervised model;
estimating, based on the plurality of batches, a new accuracy measurement that is based on the new hyperparameter value; and
training, based on the new hyperparameter value and in response to detecting that the new accuracy measurement exceeds an accuracy threshold, the unsupervised model with the plurality of batches.

16. The one or more non-transitory computer-readable media of claim 15 wherein:
the sequence of batches of datapoints includes an other batch that is not the last batch of datapoints;
said predicting the new hyperparameter value comprises averaging a plurality of hyperparameter values that includes the hyperparameter value for the last batch and the hyperparameter value for the other batch.

17. The one or more non-transitory computer-readable media of claim 15 wherein the instructions further cause avoiding, in response to said detecting, hyperparameter tuning based on the corpus of batches.

18. The one or more non-transitory computer-readable media of claim 15 wherein said estimating is based on a strict subset of the datapoints in the plurality of batches that contains a strict subset of the new datapoints.

19. The one or more non-transitory computer-readable media of claim 15 wherein said predicting the new hyperparameter value comprises reusing the hyperparameter value for the last batch of datapoints.

20. The one or more non-transitory computer-readable media of claim 15 wherein said predicting the new hyperparameter value comprises forecasting based on a timeseries that contains the datapoints in the sequence of batches of datapoints.
